(19) United States
(12) Patent Application Publication
(10) Pub. No.: US 2010/0325400 A1
(43) Pub. Date: Dec. 23, 2010

(54) MICROPROCESSOR AND DATA WRITE-IN METHOD THEREOF

(75) Inventor: Shou-Hua SHE, Hsinchu City (TW)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: RDC SEMICONDUCTOR CO., LTD., Hsinchu City (TW)

(21) Appl. No.: 12/637,305

(22) Filed: Dec. 14, 2009

(30) Foreign Application Priority Data
Jun. 23, 2009 (TW) 098120966

(51) Int. Cl. G06F 9/312

(52) U.S. Cl. 712/225; 712/E09.033

(57) ABSTRACT

A microprocessor comprises a register set, a micro operations pool (Uops pool), a hazard detection unit, an execution unit, a dispatch unit, and a mask unit. The Uops pool receives a first micro operation and a second micro operation from a decoder, and reads at least one first operand of the first micro operation and at least one second operand of the second micro operation from the register set. The hazard detection unit detects that the first micro operation is in a write after write hazard state due to the second micro operation. The execution unit executes the first micro operation dispatched from the Uops pool to obtain a first operation result and executes the second micro operation dispatched from the Uops pool to obtain a second operation result. The mask unit protects the first operation result from writing back to the register set according to the write after write hazard state.

This application claims the benefit from the priority of Tawian Patent Application No. 098120966 filed on Jun. 23, 2009, the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to a microprocessor and a data write-in method thereof. More particularly, the microprocessor and the data write-in method thereof of the present invention use a hazard detection unit and a mask unit to prevent a Write after Write (WAW) hazard.

2. Descriptions of the Related Art

With advancement in science and technology, computers have become an indispensable tool in people's daily life. Among various hardware devices of computers, microprocessors act as a core component that has a direct influence on execution speed of the computers. Accordingly, as data amount to be processed by the microprocessors becomes increasingly huger, ever heightened requirements are being imposed on the execution speed of microprocessors. Owing to rapid development of microprocessor designs in recent years, microprocessors with an out-of-order execution function have been developed. Because such microprocessors can remarkably improve the execution speed as compared to those having an in-order execution function, they have been widely accepted as the mainstream design of microprocessors.

Referring to FIG. 1, a conventional microprocessor 1 having an out-of-order execution function is depicted therein. The microprocessor 1 comprises a decoder 101, a register set 103, a micro operations pool (Uops pool) 105, a dispatch unit 107, an execution unit 109 and a re-order buffer (ROB) 111. The decoder 101 is configured to decode a computer instruction into a micro operation 102. The Uops pool 105 is configured to receive the micro operation 102 from the decoder 101 and read an operand 104 of the micro operation 102 from the register set 103, and register the micro operation 102 and the operand 104.

After the micro operation 102 and the operand 104 have both been read and registered into the Uops pool 105, the dispatch unit 107 dispatches the micro operation 102 and the operand 104 to the execution unit 109. It should be appreciated that, before being dispatched to the execution unit 109, the micro operation 102 is in an in-order execution status; but after being dispatched to the execution unit 109, the micro operation 102 may be in an out-of-order status. Briefly speaking, when dispatching the micro operation 102, the dispatch unit 107 only considers whether the micro operation 102 and the operand 104 thereof have both been registered into the Uops pool 105, but does not consider whether or not dispatching the micro operation 102 at this moment will cause a Write after Write (WAW) hazard.

After receiving the micro operation 102 and the operand 104 thereof, the execution unit 109 executes the micro operation 102 to generate an operation result 106, which is then saved in the ROB 111 and forwarded to the Uops pool 105 as an operand of an associated micro operation registered in the Uops pool 105. In other words, the operation result 106 forwarded to the Uops pool 105 corresponds to an identification (ID) code of the micro operation 102, and a micro operation with an operand to be read in the Uops pool 105 determines whether to use the forwarded operation result 106 as an operand thereof according to the ID code. Then, the ROB 111 registers and reorders the operation result 106 into an operation result 108 in the original in-order execution status. Finally, the ROB 111 writes the operation result 108 back into the register set 103 in sequence.

Likewise, as will be readily appreciated by any of those skilled in the art, the operation result 108 is also forwarded to the Uops pool 105, and also corresponds to an ID code of the micro operation 102. Hence, a micro operation with an operand to be read in the Uops pool 105 determines whether to use the forwarded operation result 108 as an operand thereof according to the ID code. It should be appreciated that, in the Uops pool 105, there might exist a micro operation having a lower execution order, which is read into the Uops pool 105 at a time point between the moment when the operation result 106 is forwarded to the Uops pool 105 and the moment when the operation result 108 is forwarded to the Uops pool 105. Hence, the micro operation having the lower execution order will read the forwarded operation result 108 as an operand thereof. Briefly speaking, operands necessary for the micro operation is not necessarily read from the register set 103, but may also be obtained from the ROB 111 or the execution unit 109, which will not be further described herein.

Because the microprocessor 1 needs to utilize the ROB 111 to reorder the operation result generated by the out-of-order execution into the original in-order execution status, this adds to complexity and power consumption of the microprocessor 1. On the other hand, implementation of the ROB 111 necessitates use of additional registers and circuits, which means a larger amount of hardware needed and drives the hardware cost of the microprocessor to be higher.

Accordingly, efforts still have to be made in the art to reduce complexity and power consumption of microprocessors and reduce the amount of hardware needed while still maintaining the performance of the microprocessors, thereby to minimize the cost thereof.

### SUMMARY OF THE INVENTION

An objective of the present invention is to provide a microprocessor, which comprises a register set, a micro operation (Uops) pool, a hazard detection unit, an execution unit, a dispatch unit and a mask unit. The Uops pool is configured to register a first micro operation, a second micro operation, at least a first operand of the first micro operation and at least a second operand of the second micro operation. The hazard detection unit is electrically connected to the Uops pool and configured to detect whether the first micro operation is in a Write after Write (WAW) hazard status due to the second micro operation. The dispatch unit is configured to, after the at least a first operand and the at least a second operand have been read and registered into the Uops pool, dispatch the first micro operation and the at least a first operand from the Uops pool to the execution unit, and dispatch the second micro operation and the at least a second operand from the Uops pool to the execution unit. The execution unit is configured to execute the first micro operation to obtain a first operation result and execute the second micro operation to obtain a second operation result. When the hazard detection unit detects that the first micro operation is in the WAW hazard status due to the second micro operation, the mask unit prevents the first operation result from being written back into the register set according to the WAW hazard status.

Another objective of the present invention is to provide a data write-in method for a microprocessor. The microprocessor comprises a register set, a Uops pool, a hazard detection unit, an execution unit, a dispatch unit and a mask unit. The data write-in method comprises the steps of: (a) detecting that a first micro operation registered in the Uops pool is in a WAW hazard status due to a second micro operation registered in the Uops pool; (b) dispatching the first micro operation and at least a first operand of the first micro operation from the Uops pool to the execution unit; (c) dispatching the second micro operation and at least a second operand of the second micro operation from the Uops pool to the execution unit; (d) enabling the execution unit to execute the first micro operation to obtain a first operation result; (e) enabling the execution unit to execute the second micro operation to obtain a second operation result; (f) preventing the first operation result from being written back into the register set according to the WAW hazard status; and (g) writing the second operation result back into the register set from the execution unit according to the WAW hazard status.

The present invention provides a microprocessor having an out-of-order execution function and a data write-in method thereof, so the micro operations in the microprocessor may be executed either in order or out of order. By detecting in advance whether a micro operation will be in the WAW hazard status due to another micro operation, it can be determined whether to write an operation result of the micro operation back into the register set after the micro operation has been executed. Accordingly, the microprocessor of the present invention can prevent WAW hazards caused by execution orders of micro operations.

Compared to the prior art, the present invention prevents WAW hazards by means of the hazard detection unit and the mask unit. Therefore, the microprocessor provided in the present invention can have operation results, which need to be written back into the register set, written back directly without need of an ROB. This reduces complexity and power consumption of the microprocessor and reduces the amount of hardware needed while still maintaining the performance of the microprocessor, thereby minimizing the cost thereof.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a prior art microprocessor;

FIG. 2 is a schematic view of a microprocessor of a first embodiment; and

FIGS. 3A-3C illustrate a flowchart of a data write-in method for a microprocessor.

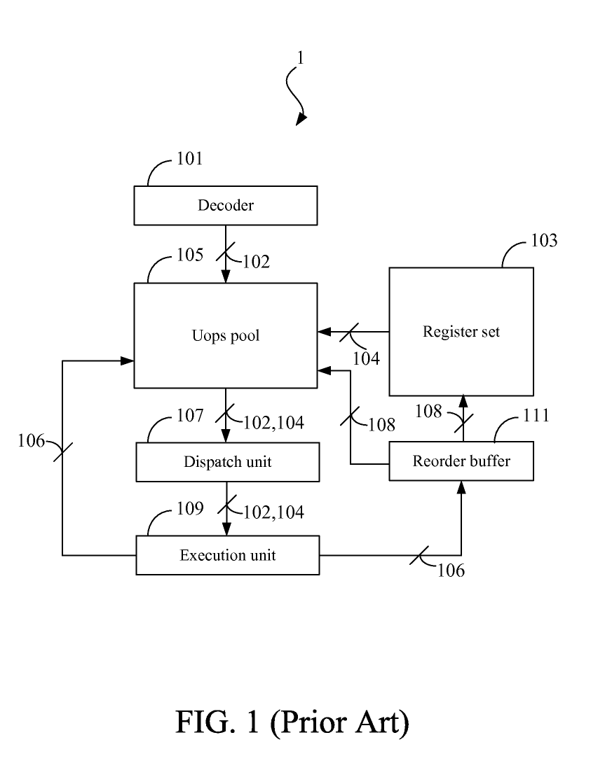

### DESCRIPTION OF THE PREFERRED EMBODIMENT

The present invention provides a microprocessor and a data write-in method thereof, which prevent a WAW hazard status by use of a hazard detection unit and a mask unit. The following embodiments are only provided to illustrate but not to limit the present invention. It should be appreciated that, in the following embodiments and the attached drawings, elements unrelated to this invention are omitted from depiction; and dimensional relationships among individual elements in the attached drawings are illustrated only for ease of understanding, but not to limit the actual scale.

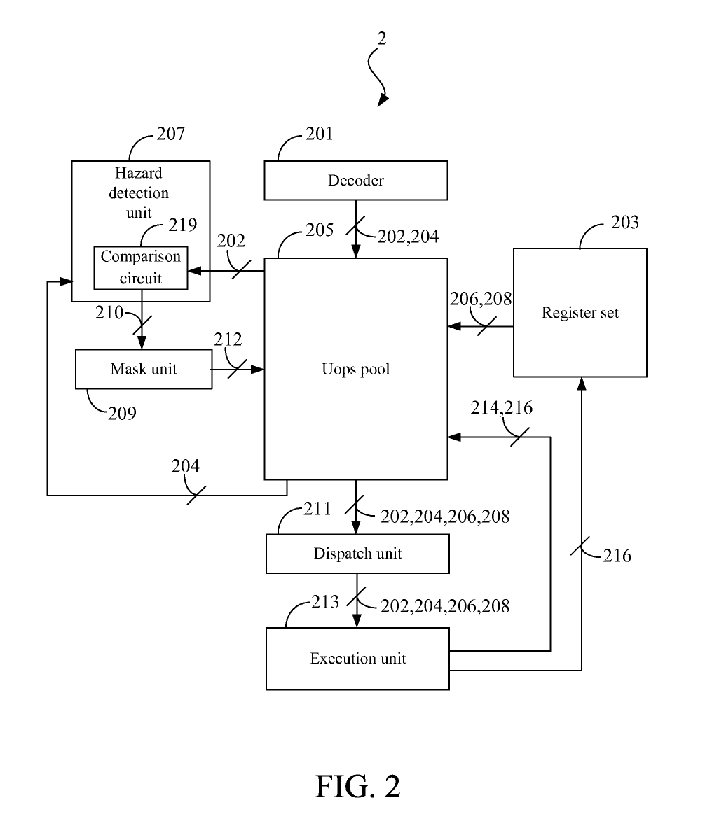

A first embodiment of the present invention is a microprocessor 2, a schematic view of which is shown in FIG. 2. The microprocessor 2 comprises a decoder 201, a register set 203, a Uops pool 205, a hazard detection unit 207, a mask unit 209, a dispatch unit 211, and an execution unit 213. The hazard detection unit 207 is electrically connected to the Uops pool 205, and the mask unit 209 is electrically connected to the hazard detection unit 207 and the Uops pool 205. The Uops pool 205 may consist of a plurality of registers.

The decoder 201 decodes a computer instruction into a first micro operation 202 and a second micro operation 204, which are then received by the Uops pool 205. Each of the first micro operation 202 and the second micro operation 204 may be one of an instruction unit (IU) micro operation and a memory management unit (MMU) micro operation. The Uops pool 205 reads at least a first operand 206 of the first micro operation 202 from the register set 203 according to the first micro operation 202, and reads at least a second operand 208 of the second micro operation 204 from the register set 203 according to the second micro operation 204. For example, if the micro operation is “ADD AX, BX”, then two operands shall be read from the register set 203, i.e., AX and BX. If the micro operation is “MOV AX, BX”, then one operand shall be read from the register set 203, i.e., BX. It should be particularly noted that, in this embodiment, the terms “first” and “second” are only used to distinguish the original micro operation (Uop) order of the first micro operation 202 and the second micro operation 204 relative to each other (i.e., if the microprocessor lacks the out-of-order execution function and the operations must be executed in order, the first micro operation 202 would be dispatched at first to the execution unit 213 for execution before the second micro operation 204 can be dispatched to the execution unit 213 for execution). In other words, the technology of the present invention can be implemented even if there exist other micro operations between the first micro operation 202 and the second micro operation 204.

Afterwards, the Uops pool 205 registers the first micro operation 202, the second micro operation 204, the first operand 206 and the second operand 208. It should be noted that, as will be appreciated by those of ordinary skill in the art from the above descriptions, reading the first operand 206 and the second operand 208 from the register set 203 refers to reading data necessary for the first operand 206 and data necessary for the second operand 208 from the register set 203, e.g., reading data stored in a register AX. Moreover, the number of micro operations that can be registered by the Uops pool 205 is only limited by of practical hardware configuration of the microprocessor. In other words, the Uops pool 205 may register more than two micro operations, and in this embodiment, only the first micro operation 202 and the second micro operation 204 are described to explain the present invention.

The first micro operation 202 corresponds to a first valid bit for indicating that the first operand 206 has been read and registered into the Uops pool 205, and the second micro operation 208 corresponds to a second valid bit for indicating that the second operand 208 has been read and registered into the Uops pool 205. The first valid bit and the second valid bit are registered in the Uops pool. For example, if a valid bit is 0, it means that the corresponding operand has not be read and registered; otherwise; if the valid bit is 1, it means that the corresponding operand has been read and registered. From the Uops pool 205, the dispatch unit 211 dispatches the first micro operation 202 and the first operand 206 to the execution unit 213 according to the first valid bit (e.g., 1), and dispatches the second micro operation 204 and the second operand 208 to the execution unit 213 according to the second valid bit (e.g., 1). It should be appreciated that, in other examples, other mechanisms may also be adopted to indicate whether the first operand 206 and the second operand 208 have been read and registered into the Uops pool 205.

Next, the case of out-of-order execution will be described. When the second operand 208 is read and registered into the Uops pool 205 earlier than the first operand 206, the dispatch unit 211 will dispatch the second micro operation 204 and the second operand 208 to the execution unit 213 at first. Then, the execution unit 213 executes the second micro operation 204 to obtain a second operation result 216, forwards the second operation result 216 to the Uops pool 205, and writes the second operation result 216 back into the register set 203. Afterwards, when the at least a first operand 206 is read and registered into the Uops pool 205, the dispatch unit 211 dispatches the first micro operation 202 and the first operand 206 to the execution unit 213 so that the execution unit 213 executes the first micro operations 202 to obtain a first operation result 214.

In the case described above, after the second micro operation 204 is dispatched, the hazard detection unit 207 detects whether the first micro operation 202 is in a WAW hazard status due to the second micro operation 204. If the first micro operation 202 is in a WAW hazard status due to the second micro operation 204, the mask unit 209 will prevent the first operation result 214 from being written back into the register set 203 according to the WAW hazard status. Consequently, the first operation result 214 is only forwarded to the Uops pool 205 but not written back into the register set 203, so as to prevent the WAW hazard caused by writing the first operation result 214 back into the register set 203 at a time later than the second operation result 216. Conversely, if the first micro operation 202 is not in a WAW hazard status due to the second micro operation 204, the first operation result 214 will naturally be forwarded to the Uops pool 205 and written back into the register set 203.

Furthermore, the first micro operation 202 has a first ID code and the second micro operation 204 has a second ID code. The first ID code and the second ID code represent the original Uop order of the first micro operation 202 and the original Uop order of the second micro operation 204 respectively. In this embodiment, a micro operation with a smaller ID code has a higher execution priority; however, in other embodiments, it may be stipulated that a micro operation with a greater ID code has a higher execution priority. It should be noted that, if the micro operation lacks the out-of-order execution function, the first micro operation 202 and the second micro operation 204 must be executed in order, which means that the first micro operation 202 must be dispatched at first to the execution unit 213 for execution before the second micro operation 204 is dispatched to the execution unit 213 for execution. In contrast, the microprocessor 2 of this embodiment is a microprocessor with the out-of-order execution function, so when the second operand 208 of the second micro operation 204 is read and registered into the Uops pool 205 earlier than the first operand 206, the second micro operation 204 and the second operand 208 thereof will be dispatched at first to the execution unit 213 even if the first ID code of the first micro operations 202 is smaller than the second ID code of the second micro operation 204 (i.e., the original Uop order of the first micro operation 202 precedes that of the second micro operation 204). However, in other examples, the original Uop orders represented by the ID codes may also be in a descending order, i.e., the first ID code greater than the second ID code may also represent that the preset execution order of the first micro operation 202 precedes that of the second micro operation 204, so scope of the present invention is not limited by whether the original Uop orders represented by the ID codes are in a descending order or in an ascending order.

Hereinafter, an example in which the mask unit 209 processes the WAW hazard status will be further described. The first micro operation 202 corresponds to a first destination code which is stored in the Uops pool 205, and a destination register indicated by the first destination code is configured to store the first operation result 214. Similarly, the second micro operation 204 corresponds to a second destination code which is stored in the Uops pool 205, and a destination register indicated by the second destination code is configured to store the second operation result 216. The destination register indicated by the first destination code and the destination register indicated by the second destination code are from the register set 203.

If the first destination code and the second destination code are identical, then the first operation result 104 and the second operation result 216 have to be written back into a same register. In this case, the first micro operation 202 may come into a WAW hazard status if the second micro operation 204 is firstly executed and written back into the destination register. If the first micro operation 202 is in the WAW hazard status due to the second micro operation 204, then the mask unit 209 will, prior to execution of the first micro operation, mask the first destination code according to the WAW hazard status, thereby to prevent the execution unit 213 from writing the first operation result 214 back into the destination register indicated by the original first destination code. For example, the mask unit 209 can replace the first destination code with a preset code 212. As the first destination code has been replaced, the first operation result 214 will be written back into a register indicated by the preset code 212 to prevent the WAW hazard status. On the other hand, according to the second destination code, the execution unit 213 will write the second operation result 216 back into the destination register indicated by the second destination code. Both the first operation result 214 and the second operation result 216 are forwarded to the Uops pool 205.

Now, an example in which the hazard detection unit 207 detects a WAW hazard status will be further described. The hazard detection unit 207 comprises a comparison circuit 219. If the first destination code is identical to the second destination code, then when the second micro operation 204 is dispatched to the execution unit 213, the hazard detection unit 207 will detect whether the first micro operation 202 is in a WAW hazard status due to the second micro operation 204 by comparing a value of the first ID code with that of the second ID code. In this embodiment, the micro operation with a smaller ID code has a higher execution priority; however, in other embodiments, it may be stipulated that the micro operation with a greater ID code has a higher execution priority. If the first micro operation 202 is in a WAW hazard status due to the second micro operation 204, then the hazard detection unit 207 transmits an instruction signal 210 to the mask unit 209 to instruct the mask unit 209 to replace the first destination code with a preset code 212 as described above. In this way, the first destination code is masked to prevent the execution unit 213 from writing the first operation result 214 back into the destination register indicated by the first destination code.

The above description of the first embodiment will become more apparent by reviewing Tables 1 and 2 below.

TABLE 1

| | | Destination | |
|---|---|---|---|
| ID code | Micro operation | code | Valid bit |
| 1 | ADD AX, BX | 4 | 0 |
| 2 | MOV AX, DX | 4 | 1 |

Referring to Table 1, information related to two micro operations stored in the Uops pool 205 is shown therein. Specifically, the first micro operation 202 is “ADD AX, BX”, first ID code of the first micro operation 202 is “1”, the second micro operation 204 is “MOV AX, DX”, and the second ID code of the second micro operation 204 is “2”. As the first ID code is smaller than the second ID code, it can be known that the original Uop order of the first micro operation 202 (i.e., “ADD AX, BX”) precedes that of the second micro operation 204 (i.e., “MOV AX, DX”).

Because the second valid bit of the second micro operation 204 (i.e., “MOV AX, DX”) is “1”, which means that the second operand 208 needed (i.e., the value of “DX”) has been read from the register set 203 and registered into the Uops pool 205, the second micro operation 204 can be dispatched by the dispatch unit 211 to the execution unit 213 for execution. Because the valid bit of the first micro operation 202 (i.e., “ADD AX, BX”) is “0”, which means that the first operand 206 needed (i.e., the values of “AX” and “BX”) has not been read and registered into the Uops pool 205, the first micro operation 202 can not be dispatched by the dispatch unit 211 to the execution unit 213 for execution. In this case, the second micro operation 204 (i.e., “MOV AX, DX”) is dispatched to the execution unit 213 for execution before the first micro operation 202 (i.e., “ADD AX, BX”).

Then according to the second destination code “4” (i.e., representing the destination register corresponding to “AX”) of the second micro operation 204 (i.e., “MOV AX, DX”), the hazard detection unit 207 detects that the first micro operation 202 (i.e., “ADD AX, BX”) has the same destination code, and compares the first ID code of the first micro operation 202 (i.e., “ADD AX, BX”) with the second ID code of the second micro operation 204 (i.e., “MOV AX, DX”). When the comparison circuit 219 of the hazard detection unit 207 determines that the first ID code (i.e., “1”) of the first micro operation 202 (i.e., “ADD AX, BX”) is smaller than the second ID code (i.e., “2”) of the second micro operation 204 (i.e., “MOV AX, DX”), the hazard detection unit 207 ascertains that the first micro operation 202 (i.e., “ADD AX, BX”) is in the WAW hazard status due to the second micro operation 204 (i.e., “MOV AX, DX”). At this point, the hazard detection unit 207 transmits an instruction signal to the mask unit 209, which masks the first destination code of the first micro operation 202 (i.e., “ADD AX, BX”) with a preset code “-” according to the instruction signal, as shown in Table 2. Consequently, when the first micro operation 202 (i.e., “ADD AX, BX”) is dispatched to the execution unit 213, it is impossible for the execution unit 213 to write the first operation result 214 back into the register set 203 according to the preset code “-”, thereby accomplishing the purpose of preventing the first operation result 214 from being written back into the register set 203. Additionally, because the second micro operation 204 has been dispatched, information related to the second micro operation 204 is absent from Table 2.

TABLE 2

| | | Destination | |
|---|---|---|---|
| ID code | Micro operation | code | Valid bit |
| 1 | ADD AX, BX | — | 0 |

It should be noted that, in other examples, the WAW hazard status may refer to a WAW hazard status of a flag register. When the hazard detection unit detects that a first micro operation is in a WAW hazard status due to a second micro operation, the mask unit will prevent a first operation result of the first micro operation from being written back into a flag register included in the register set. It should be particularly emphasized that, the first operation result mentioned herein is a status resulting from execution of the first micro operation. Additionally, after execution of different micro operations, one or more different statuses may be involved, in which case one or more destination codes may be used to accomplish the purpose of the present invention. In more detail, the first operation result may comprise a plurality of values and a plurality of statuses resulting from execution of the first micro operation, so a plurality of destination codes are needed to have the different values written back into different registers and the different statuses written back into different flag registers.

For example, if the first micro operation is “ADD AX, BX”, then the flag register involved may be an overflow flag register configured to record whether an overflow status occurs after the additive operation of the micro operation “ADD AX, BX”. The second micro operation “ADD CX, DX” has the same destination code as the first micro operation “ADD AX, BX”, and because both the first micro operation “ADD AX, BX” and the second micro operation “ADD CX, DX” can change the same overflow flag register, the first micro operation is exposed to the risk of the WAW hazard. Therefore, in the same way as described in the first embodiment, the microprocessor can eliminate the WAW hazard caused by using the same overflow flag register. Upon reviewing the first embodiment, any of those skilled in the art will readily appreciate how this is accomplished and also appreciate that the microprocessor may comprise a plurality of different flag registers, so no further description will be made again herein.

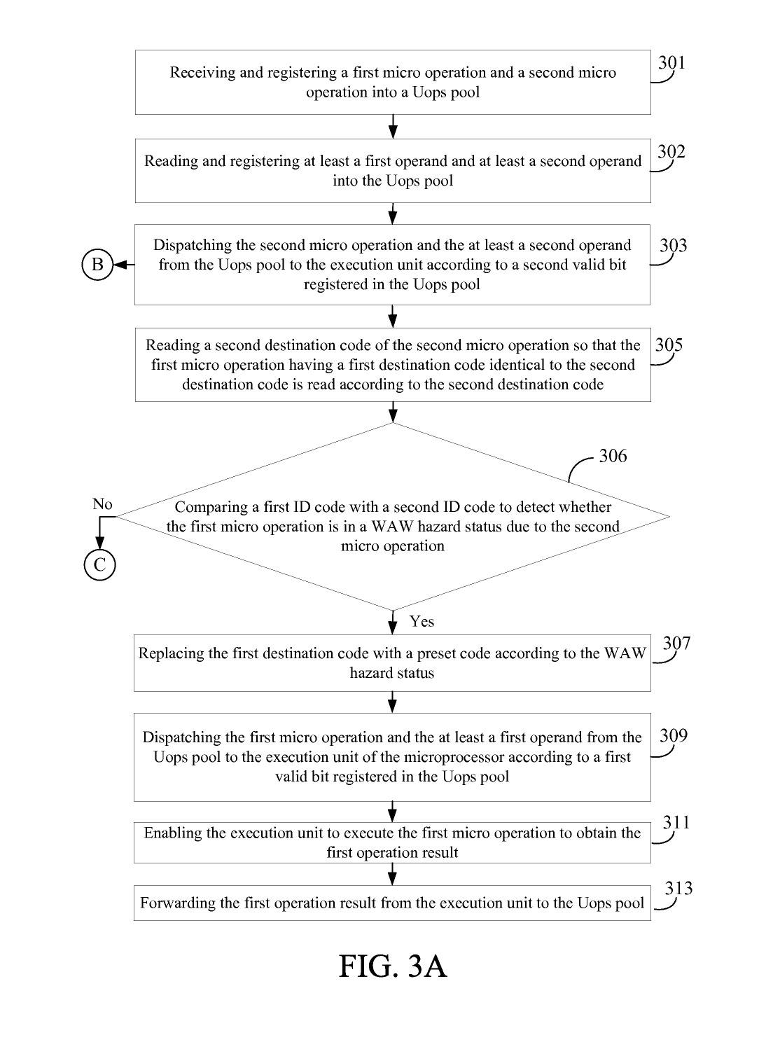

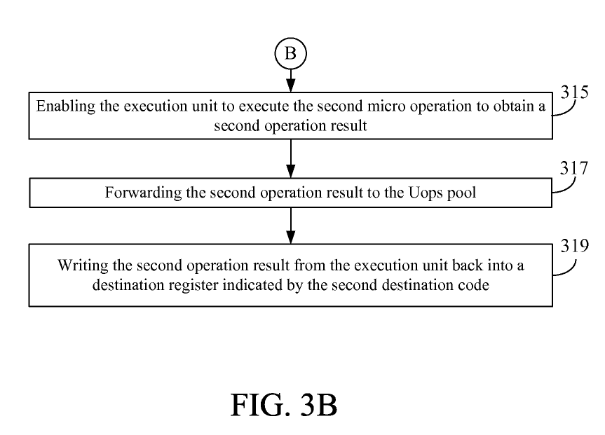

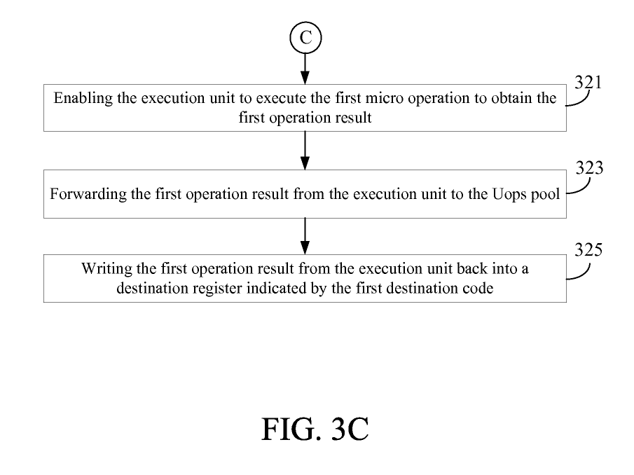

A second embodiment of the present invention is a data write-in method for a microprocessor (e.g., the microprocessor 2 of the first embodiment), a flowchart of which is depicted in FIGS. 3A-3C. Initially, step 301 is executed to enable the microprocessor to receive a first micro operation and a second micro operation from a decoder and register them into a Uops pool. The data write-in method has no limitation on the order in which the first micro operation and the second micro operation are received. Next, step 302 is executed to read at least a first operand of the first micro operation and at least a second operand of the second micro operation from a register set and register the at least a first operand and the at least a second operand into the Uops pool. Similarly, the data write-in method has no limitation on the order in which the at least a first operand and the at least a second operand are read.

Then, step 303 is executed to dispatch the second micro operation and the at least a second operand of the second micro operation to the execution unit of the microprocessor according to a second valid bit registered in the Uops pool. It should be appreciated that, the second valid bit (e.g., having a value of 1) is configured to indicate that the second operand has been red and registered into the Uops pool. Subsequently, steps 305 and 315 are executed respectively.

In step 305, a second destination code of the second micro operation is read so that the first micro operation having a first destination code identical to the second destination code can be detected according to the second destination code. Then step 306 is executed to compare a first ID code of the first micro operation with a second ID code of the second micro operation to detect whether the first micro operation is in a WAW hazard status due to the second micro operation. If the first micro operation is in the WAW hazard status due to the second micro operation, then step 307 is executed to mask the first destination code by replacing the first destination code with a preset code according to the WAW hazard status, so as to prevent a first operation result from being written from the execution unit back into a destination register indicated by the first destination code. Afterwards, step 309 is executed to dispatch the first micro operation and the at least a first operand of the first micro operation to the execution unit of the microprocessor according to a first valid bit registered in the Uops pool, where the first valid bit is configured to indicate that the first operand has been read and registered into the Uops pool. Next, step 311 is executed to enable the execution unit to execute the first micro operation to obtain the first operation result. Finally, step 311 is executed to forward the first operation result from the execution unit to the Uops pool.

Additionally, following step 303, step 315 is further executed to enable the execution unit to execute the second micro operation to obtain a second operation result. Then, step 317 is executed to forward the second operation result to the Uops pool, and step 319 is executed to write the second operation result from the execution unit back into a destination register indicated by the second destination code.

Further, if the first micro operation is not in the WAW hazard status due to the second micro operation, then step 321 is executed to enable the execution unit to execute the first micro operation to obtain the first operation result. Then, step 323 is executed to forward the first operation result from the execution unit to the Uops pool, and step 325 is executed to write the first operation result from the execution unit back into a destination register indicated by the first destination code.

According to the above descriptions, the microprocessor of the present invention is provided with an out-of-order execution function, so when the second micro operation 204 is dispatched to the execution unit 213 earlier than the first micro operation 202 and the first micro operation 202 and the second micro operation 204 have identical destination codes (i.e., the first destination code and the second destination code), the comparison circuit 219 of the hazard detection unit 207 will detect whether the first micro operation is in the WAW hazard status by comparing the first ID code of the first micro operation with the second ID code of the second micro operation. Once a WAW hazard status is detected, the first destination code of the first micro operation 202 is masked by the mask unit 209 to prevent the execution unit 213 from writing the first operation result 214 back into the destination register, thereby preventing the WAW hazard. Consequently, the microprocessor of the present invention is provided with the out-of-order execution function without need of a re-order buffer (ROB). In this way, the present invention remarkably reduces the complexity and power consumption of the microprocessor and reduces the amount of hardware needed while still maintaining the performance of the microprocessor, thereby minimizing the cost thereof.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A microprocessor, comprising:
a register set;
a micro operations (Uops) pool, being configured to register a first micro operation, a second micro operation, at least a first operand of the first micro operation, and at least a second operand of the second micro operation;
a hazard detection unit electrically connected to the Uops pool, being configured to detect that the first micro operation is in a write after write (WAW) hazard status due to the second micro operation;
an execution unit, being configured to execute the first micro operation dispatched from the Uops pool to obtain a first operation result and execute the second micro operation dispatched from the Uops pool to obtain a second operation result;
a dispatch unit, being configured to dispatch the first micro operation and the first operand from the Uops pool to the execution unit, and dispatch the second micro operation and the second operand from the Uops pool to the execution unit; and
a mask unit electrically connected to the hazard detection unit and the Uops pool, being configured to prevent the first operation result from being written back to the register set according to the WAW hazard status.

2. The microprocessor as claimed in claim 1, wherein the Uops pool is configured to store a first destination code corresponding to the first micro operation, and the mask unit is configured to, before the execution unit executes the first micro operation, mask the first destination code according to the WAW hazard status to prevent the execution unit from writing the first operation result back to a destination register indicated by the first destination code, wherein the register set comprises the destination register.

3. The microprocessor as claimed in claim 2, wherein the mask unit is configured to mask the first destination code by replacing the first destination code with a preset code.

4. The microprocessor as claimed in claim 2, wherein the execution unit is further configured to forward the first operation result to the Uops pool.

5. The microprocessor as claimed in claim 4, wherein the Uops pool is configured to store a second destination code corresponding to the second micro operation, the second destination code is identical to the first destination code, and the execution unit is further configured to write the second operation result back to the destination register indicated by the second destination code.

6. The microprocessor as claimed in claim 5, wherein the execution unit is further configured to forward the second operation result to the Uops pool.

7. The microprocessor as claimed in claim 6, wherein the first micro operation has a first identification (ID) code, and the second micro operation has a second ID code.

8. The microprocessor as claimed in claim 7, wherein the first ID code and the second ID code represent the original Uop order of the first micro operation and the second micro operation respectively, and the first ID code is smaller than the second ID code.

9. The microprocessor as claimed in claim 8, wherein the hazard detection unit comprises a comparison circuit configured to, when the first destination code and the second destination code are identical, detect that the first micro operation is in the WAW hazard status due to the second micro operation by comparing the first ID code with the second ID code.

10. The microprocessor as claimed in claim 7, wherein the first ID code and the second ID code represent the original Uop order of the first micro operation and the second micro operation respectively, and the first ID code is greater than the second ID code.

11. The microprocessor as claimed in claim 10, wherein the hazard detection unit comprises a comparison circuit configured to, when the first destination code and the second destination code are identical, detect that the first micro operation is in the WAW hazard status due to the second micro operation by comparing the first ID code with the second ID code.

12. The microprocessor as claimed in claim 1, wherein the Uops pool is further configured to receive the first micro operation and the second micro operation from a decoder, and reads the at least a first operand and the at least a second operand from the register set.

13. The microprocessor as claimed in claim 12, wherein the first micro operation corresponds to a first valid bit registered in the Uops pool and configured to indicate that the at least a first operand has been read and registered into the Uops pool, and the second micro operation corresponds to a second valid bit registered in the Uops pool and configured to indicate that the at least a second operand has been read and registered into the Uops pool.

14. The microprocessor as claimed in claim 13, wherein the dispatch unit is configured to dispatch the first micro operation and the first operand from the Uops pool to the execution unit according to the first valid bit, and dispatch the second micro operation and the second operand from the Uops pool to the execution unit according to the second valid bit.

15. The microprocessor as claimed in claim 1, wherein the Uops pool is configured to store a first destination code corresponding to the first micro operation, and the mask unit is further configured to, before the execution unit executes the first micro operation, mask the first destination code according to the WAW hazard status to prevent the execution unit from writing the first operation result back to a flag register indicated by the first destination code, and wherein the register set comprises the flag register.

16. The microprocessor as claimed in claim 1, wherein the first micro operation is one of an instruction unit (IU) micro operation and a memory management unit (MMU) micro operation, and the second micro operation is one of an IU micro operation and a MMU micro operation.

17. A data write-in method adapted for a microprocessor, the data write-in method comprising the steps of:
(a) detecting that a first micro operation registered in a Uops pool of the microprocessor is in a WAW hazard status due to a second micro operation registered in the Uops pool;
(b) dispatching the first micro operation and at least a first operand of the first micro operation from the Uops pool to an execution unit of the microprocessor;
(c) dispatching the second micro operation and at least a second operand of the second micro operation from the Uops pool to the execution unit;
(d) enabling the execution unit to execute the first micro operation to obtain a first operation result;
(e) enabling the execution unit to execute the second micro operation to obtain a second operation result;
(f) preventing the first operation result from being written back into a register set of the microprocessor according to the WAW hazard status; and
(g) writing the second operation result back into the register set according to the WAW hazard status.

18. The data write-in method as claimed in claim 17, wherein the Uops pool is configured to store a first destination code corresponding to the first micro operation, the step (f) is executed before the step (d), and the step (f) masks the first destination code according to the WAW hazard status to prevent the first operation result from being written from the execution unit back to a destination register indicated by the first destination code, wherein the register set comprises the destination register.

19. The data write-in method as claimed in claim 18, wherein the step (f) masks the first destination code by replacing the first destination code with a preset code.

20. The data write-in method as claimed in claim 18, further comprising the step of:
forwarding the first operation result from the execution unit to the Uops pool after the step (d).

21. The data write-in method as claimed in claim 20, wherein the Uops pool is configured to store a second destination code corresponding to the second micro operation, and the second destination code is identical to the first destination code, the data write-in method further comprising the step of:
writing the second operation result from the execution unit back to the destination register indicated by the second destination code.

22. The data write-in method as claimed in claim 21, further comprising the step of:
forwarding the second operation result from the execution unit to the Uops pool after the step (e).

23. The data write-in method as claimed in claim 22, wherein the first micro operation has a first ID code, and the second micro operation has a second ID code.

24. The data write-in method as claimed in claim 23, wherein the first ID code and the second ID code represent the original Uop order of the first micro operation and the second micro operation respectively, and the first ID code is smaller than the second ID code.

25. The data write-in method as claimed in claim 24, wherein when the first destination code and the second destination code are identical, the step (a) detects that the first micro operation is in the WAW hazard status due to the second micro operation by comparing the first ID code with the second ID code.

26. The data write-in method as claimed in claim 23, wherein the first ID code and the second ID code represent the original Uop order of the first micro operation and the second micro operation respectively, and the first ID code is greater than the second ID code.

27. The data write-in method as claimed in claim 26, wherein when the first destination code and the second destination code are identical, the step (a) detects that the first micro operation is in the WAW hazard status due to the second micro operation by comparing the first ID code with the second ID code.

28. The data write-in method as claimed in claim 17, further comprising the following steps before the step (a):
(h) receiving the first micro operation from a decoder and registering the first micro operation into the Uops pool;
(i) receiving the second micro operation from a decoder and registering the second micro operation into the Uops pool;
(j) reading the at least a first operand from the register set and registering the at least a first operand into the Uops pool; and
(k) reading the at least a second operand from the register set and registering the at least a second operand into the Uops pool.

29. The data write-in method as claimed in claim 28, wherein the step (j) further comprises the following steps of:
registering a first valid bit corresponding to the at least a first operand into the Uops pool, wherein the first valid bit is configured to indicate that the at least a first operand has been read and registered into the Uops pool.

30. The data write-in method as claimed in claim 29, wherein the step (b) dispatches the first micro operation and the at least a first operand from the Uops pool to the execution unit according to the first valid bit.

31. The data write-in method as claimed in claim 28, wherein the step (k) further comprises the following step of:
registering a second valid bit corresponding to the at least a second operand into the Uops pool, wherein the second valid bit is configured to indicate that the at least a second operand has been read and registered into the Uops pool.

32. The data write-in method as claimed in claim 31, wherein the step (c) dispatches the second micro operation and the at least a second operand from the Uops pool to the execution unit according to the second valid bit.

33. The data write-in method as claimed in claim 17, wherein the Uops pool is configured to store a first destination code corresponding to the first micro operation, the method further comprising the following step of:
masking the first destination code according to the WAW hazard status to prevent a status of the first operation result from being written from the execution unit back to a flag register indicated by the first destination code, wherein the register set comprises the flag register.

34. The data write-in method as claimed in claim 17, wherein the first micro operation is one of an IU micro operation and an MMU micro operation, the second micro operation is one of an IU micro operation and an MMU micro operation.
